(19) United States
(12) Patent Application Publication
(10) Pub. No.: US 2020/0286302 A1
(43) Pub. Date: Sep. 10, 2020

(54) Method And Apparatus For Manipulating Object In Virtual Or Augmented Reality Based On Hand Motion Capture Apparatus

(71) Applicant: Center of Human-Centered Interaction for Coexistence, Seoul (KR)

(72) Inventors: Yong Ho LEE, Seoul (KR); Dong Myoung LEE, Seoul (KR); Young Uk KIM, Seoul (KR); Jin Baek KIM, Seoul (KR); Hwang Youn KIM, Seoul (KR); Bum Jae YOU, Seoul (KR)

(21) Appl. No.: 16/810,904

(22) Filed: Mar. 6, 2020

(30) Foreign Application Priority Data
Mar. 7, 2019 (KR) 10-2019-0026246

(51) Int. Cl. G06T 19/20; G06F 3/01

(52) U.S. Cl. CPC G06T 19/20; G06F 3/017; G06F 3/016

(57) ABSTRACT

Disclosed are a method and apparatus for manipulating an object in virtual or augmented reality based on a hand motion capture apparatus providing haptic feedback. The method of manipulating an object in virtual or augmented reality based on a hand motion capture apparatus providing haptic feedback includes receiving a value of a sensor at a specific position in a finger from the hand motion capture apparatus, estimating a motion of the finger based on the value of the sensor and adjusting a motion of a virtual hand, detecting contact of the adjusted virtual hand with a virtual object, and upon detecting the contact with the virtual object, providing feedback to the user using the hand motion capture apparatus, wherein the virtual hand is modeled for each user.

### CROSS-REFERENCE TO RELATED APPLICATION

This application claims priority to and the benefit of Korean Patent Application No. 10-2019-0026246, filed on Mar. 7, 2019, the disclosure of which is incorporated herein by reference in its entirety.

### BACKGROUND OF THE INVENTION

### Field of the Invention

The present disclosure relates to a method and apparatus for manipulating an object in virtual or augmented reality based on a hand motion capture apparatus providing haptic feedback.

### Description of the Related Art

The information disclosed in this Background section is only for enhancement of understanding of the background of the invention and therefore it may contain information that does not form the prior art.

Along with development of technologies, interest in virtual reality or augmented reality has increased. In virtual reality, all of an image, a surrounding background, and an object are configured and shown in the form of a virtual image, and on the other hand, in augmented reality, the real world is mainly shown and only additional information is virtually configured and overlaid on the real world. Both virtual reality and augmented reality need to make a user feel as though they are interacting with a virtual object. In this regard, a hand motion capture apparatus for tracking hand motion of a user recognizes a user hand well in any environment and provides realistic experiences in various situations.

In this regard, a head mounted device (HMD) that is a device for allowing a user to see a virtual image, a remote controller for interaction with a virtual object, and the like have been developed. In order to enhance sense of reality in virtual reality or augmented reality, the configuration of a virtual object and graphic quality are important, but, in particular, interaction between a user and a virtual object is also important. The aforementioned developed remote controller has a limit in recognizing a detailed operation of a user because the user holds the remote controller with his or her hands. Accordingly, other technologies for overcoming this limit have been developed. For example, there are technologies for tracking a finger with an optical marker attached thereto via a camera or for measuring motion of a finger using various sensors. However, according to these technologies, a temporal or spatial gap is also formed between motions of an actual user hand and a virtual hand, and thus, during manipulation of a virtual object, sense of reality of the user is degraded. In order to enhance sense of reality in a little way, much more sensors are required, and accordingly, there is a need for other solutions to problems in terms of increased costs, data throughput, etc.

As such, in order to make a user feel as though they are interacting with a virtual object, computer haptic technology, i.e., haptics for allowing the user to feel touch is very important. An initial haptic interface device is configured in the form of a glove and transmits only motion information of a hand to a virtual environment rather than generating haptic information to a user. However, the glove that transmits only motion information of a hand is configured by excluding a haptic element that is one of important elements for recognition of an object of a virtual environment, and thus, it is difficult to maximize sense of immersion of users exposed to the virtual environment. Then, along with development of and research on haptics, haptic glove technology for transmitting tactile sensation to a user has been much developed. However, it is not possible to accurately estimate a distance by a user via virtual object manipulation in a virtual reality and augmented reality and there is no sensation based on physical contact differently from a realistic world, and thus, it is difficult to reproduce reality.

### SUMMARY OF THE INVENTION

Therefore, the present disclosure has been made in view of the above problems, and it is an object of the present disclosure to provide a method and apparatus for manipulating an object in virtual or augmented reality based on a hand motion capture apparatus providing haptic feedback.

In accordance with an aspect of the present disclosure, the above and other objects can be accomplished by the provision of a method of manipulating an object in virtual or augmented reality based on a hand motion capture apparatus providing haptic feedback, the method including receiving a value of a sensor at a specific position in a finger from the hand motion capture apparatus, estimating a motion of the finger based on the value of the sensor and adjusting a motion of a virtual hand, detecting contact of the adjusted virtual hand with a virtual object, and upon detecting the contact with the virtual object, providing feedback to the user using the hand motion capture apparatus, wherein the virtual hand is modeled for each user.

In accordance with another aspect of the present disclosure, there is provided an object manipulation apparatus in virtual or augmented reality based on a hand motion capture apparatus providing haptic feedback, the apparatus including an input unit configured to receive a value of a sensor at a specific position in a finger from the hand motion capture apparatus, a controller configured to estimate a motion of the finger based on the value of the sensor, to adjust a motion of a virtual hand, and to detect contact of the adjusted virtual hand with a virtual object, and an output unit configured to provide feedback to the user using the hand motion capture apparatus upon detecting the contact with the virtual object, wherein the controller models the virtual hand for each user.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing a motion of a hand and a finger with a hand motion capture apparatus mounted thereon for capturing a hand motion according to an embodiment of the present disclosure;

FIG. 2 is a diagram showing a mechanism for estimating a motion of a hand according to an embodiment of the present disclosure;

FIG. 3 is a diagram showing positions in a hand, which are required for modeling for each user, according to an embodiment of the present disclosure;

FIG. 4 is a diagram illustrating the case in which a physical particle is formed on a virtual hand obtained by modeling an actual hand according to an embodiment of the present disclosure;

FIG. 5 is a flowchart of a method of manipulating an object in virtual or augmented reality based on a hand motion capture apparatus providing haptic feedback according to an embodiment of the present disclosure; and

FIG. 6 is a diagram showing a configuration of an object manipulation apparatus in virtual or augmented reality based on a hand motion capture apparatus providing haptic feedback according to an embodiment of the present disclosure.

### DETAILED DESCRIPTION OF THE INVENTION

Hereinafter, at least one embodiment of the present disclosure will be described in detail with reference to the accompanying drawings. In the following description, like reference numerals designate like elements although the elements are shown in different drawings. Further, in the following description of the at least one embodiment, a detailed description of known functions and configurations incorporated herein will be omitted for clarity and brevity.

It will be understood that, although the terms first, second, A, B, (a), (b), etc. may be used herein to describe various elements of the present disclosure, these terms are only used to distinguish one element from another element and necessity, order, or sequence of corresponding elements are not limited by these terms. Throughout the specification, one of ordinary skill would understand terms “include”, “comprise”, and “have” to be interpreted by default as inclusive or open rather than exclusive or closed unless expressly defined to the contrary. Further, terms such as “unit”, “module”, etc. disclosed in the specification mean units for processing at least one function or operation, which may be implemented by hardware, software, or a combination thereof.

In addition, in the present disclosure, a joint between a finger and a palm may be referred to as a finger start point.

First, a method of estimating a finger motion using data acquired from a hand motion capture apparatus providing haptic feedback will be described.

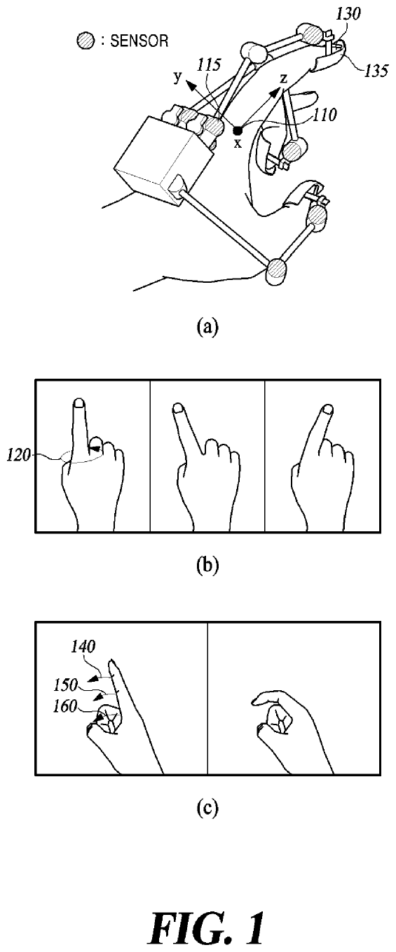

FIG. 1 is a diagram showing a motion of a hand and a finger with a hand motion capture apparatus providing haptic feedback mounted thereon for capturing a hand motion according to an embodiment of the present disclosure.

A sensor of the hand motion capture apparatus providing haptic feedback may be positioned at a specific part of the finger and may receive data from the part. In this case, the sensor may be a 3D magnetic sensor, a position sensor, an optical sensor, an acceleration sensor, a gyro sensor, or the like, but is not limited thereto. In the present disclosure, the 3D magnetic sensor will be exemplified. Referring to FIG. 1A, the specific part of the finger may be a finger start point 110 and a joint of a finger end. An angle of each rotational joint configuring an exoskeleton finger part of the hand motion capture apparatus may be acquired through data input from the sensor. A position of the finger start point 110 may be a predefined value that is the same as a start point 115 of an exoskeleton finger part and may be calculated based on the angle of each rotational joint of the exoskeleton finger part, which is acquired from the sensor, using forward kinematics (FK), and thus, a position of an end 135 of the exoskeleton finger part may be estimated. In this case, the position of the end of the exoskeleton finger part may be assumed to be the same as a finger end 130, a position of an intermediate joint may also be lastly calculated via an inverse kinematics (IK) solver based on the assumption, and a position of each joint of a joint may be estimated. That is, FK and IK solver may be sequentially applied to the data input from the sensor to estimate a motion of an actual finger. Furthermore, when the hand motion capture apparatus is used, FK may be applied to acquire the length of a finger joint.

FIGS. 1B and 1C are diagrams showing possible motions of a finger. In detail, FIG. 1B shows a yaw 120 of a motion of a finger start point. FIG. 1C is a diagram showing pitches 140, 150, and 160 of other motions of each finger joint and a finger start point.

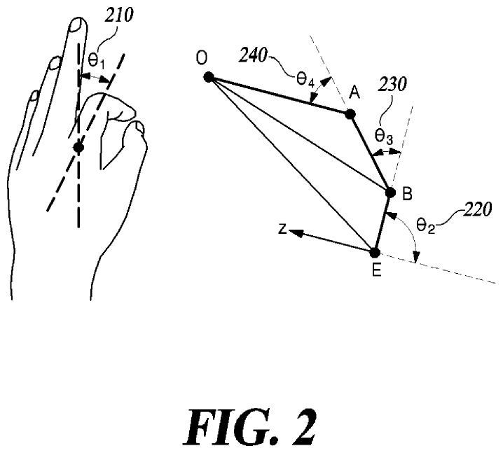

FIG. 2 is a diagram showing a mechanism for estimating a motion of a hand according to an embodiment of the present disclosure.

In order to estimate the motion of the finger, a virtual hand corresponding to a virtual hand may be used. First, a position of an end of a virtual finger and a rotational matrix may be indicated based on an origin coordinate system of the virtual finger and the position of the finger end and a start point may be calculated. Then, a position of a joint A may be calculated using an axis that is formed in a direction in which a finger stretches based on a local coordinates system of the finger end O. A yaw angle θ₁ 210 of the finger start point may be calculated using the calculated position of the joint.

The position of the finger end and a position of the joint A close thereto may be rotated by the yaw angle θ₁ 210 of the calculated finger start point to calculate a pitch angle based on a 2D coordinate system.

In detail, since all lengths of joints of the finger are known, pitch angles θ₃ and θ₄ of the remaining joints of the finger may be calculated by applying the second raw of cosines to triangle OAE.

Then, since the position of the finger end and the position of the finger close thereto are known, an angle θₜₒₜₐₗ of an end of a virtual finger may be calculated based on the coordinates system of the finger start point according to the principle of a triangle.

The pitch angle θ₂ of a finger joint may be calculated using the calculated angle of the end of the virtual finger. The pitch angle θ₂ of the finger joint may be calculated according to Equation 1 below.

θ₂=θₜₒₜₐₗ−θ₄−θ₃ [Equation 1]

Lastly, since a rotation angle and joint length of each finger are known, positions of each finger joint and end may be calculated via forward kinematics (FK).

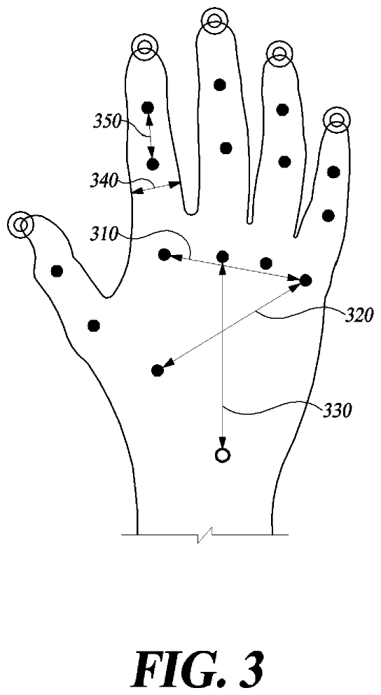

FIG. 3 is a diagram showing positions in a hand, which are required for modeling for each user, according to an embodiment of the present disclosure.

The method of measuring the positions in the hand may include a method of directly measuring a position using a sensor, for example, a glove with a sensor attached thereto, or a method of attaching a sensor directly to a hand, or a method of analyzing an image captured using an image sensor. In addition, a required position in a hand may also be measured using a separate device manufactured to measure exoskeleton of the hand, for example, a hand motion capture apparatus providing haptic feedback. When some measurement methods are used, position information may be acquired in real time. The position as a measurement target may be a position of a joint and an end of each finger.

In detail, values of a position ● of a joint between bones and each finger end ⊚ may be measured based on a joint ◯ of the wrist and information required for modeling may be calculated using the measured values. A position of the joint and a position of each finger end may be indicated by a relative coordinate value based on the joint ◯ of the wrist and may also be indicated by a 3D coordinate value. The information required for modeling of the hand may include the width, the thickness, and the length of bones configuring a palm and each finger. However, fingers are deemed to have the same width and thickness from their cylindrical shapes.

In FIG. 3, the width of the palm may be a distance 310 between a first joint of an index finger and a first joint of a little finger, the thickness of the palm may be a distance 320 between a first joint of a thumb and a first joint of the little finger, and the length of the palm may be a distance 330 between a joint of the wrist and a first joint of a middle finger. A width 340 and the thickness of a finger may be calculated using the measured position value of a joint, and the length of the finger may be a distance 350 between joints of the finger.

According to a virtual hand modeling method according to the present disclosure, new modeling is not performed, but instead, an arbitrary virtual hand may be changed, that is, adjusted using the measured position value. For example, when a finger of the arbitrary virtual hand is longer than a finger of an actual hand, the arbitrary virtual hand may be adjusted to be short, and when an arbitrary virtual hand is thicker than an actual palm, the arbitrary virtual hand may be adjusted to be thin, and accordingly, the arbitrary virtual hand may be modeled to be the same as an actual hand.

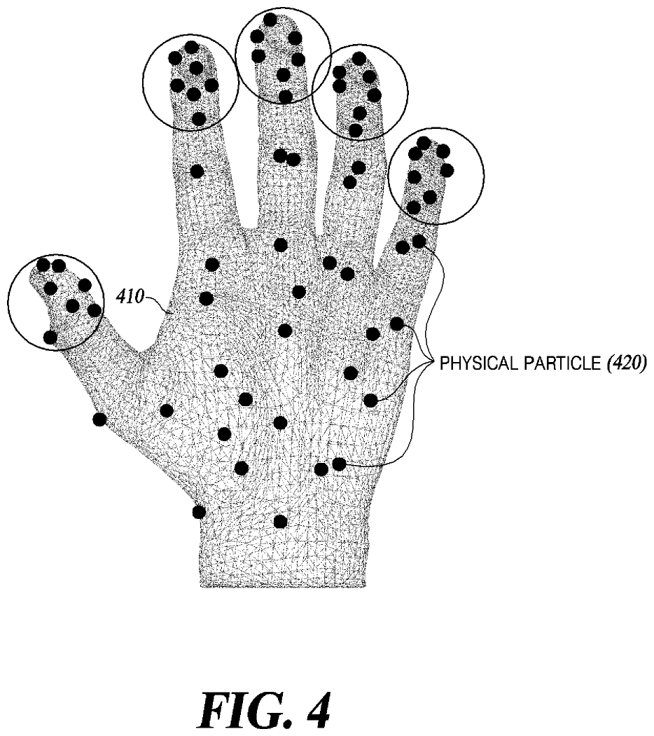

FIG. 4 is a diagram illustrating the case in which a physical particle is formed on a virtual hand obtained by modeling an actual hand according to an embodiment of the present disclosure.

According to the present disclosure, a physical model of the virtual hand model may be generated using a physical engine in order to determine interaction between a virtual hand obtained by modeling an actual hand and the virtual object. In this case, when entire mesh data of the virtual hand that is deformed in real time may be formed in a physical particle (a physical object), it is a problem in that a long computation time is taken. That is, a mesh index per hand is about 8000, and when positions of all mesh indexes that are changed in real time are applied to update an entire virtual hand physical model, the computation amount of the physical engine may be overloaded, and thus, it is not possible to process data in real time.

Accordingly, according to the present embodiment, as shown in FIG. 4, physical particles 420 may be generated only on mesh indexes on which contact occurs when a user performs a hand motion, and physical interaction may be performed using the plurality of physical particles 420. According to the present disclosure, the physical attributes of the physical particle 420 may be defined as a kinematic object and various hand motions that occur in a real world may be appropriately implemented.

According to the present disclosure, the plurality of physical particles 420 may be particles with a small size and an arbitrary shape. According to the present disclosure, the physical particles 420 may be densely distributed on the last joint of a finger, which is a mesh index on which contact mainly occurs during a hand motion, and may be uniformly distributed on an entire area of a palm, and thus, even if a smaller number of objects is used than entire mesh data, a physical interaction result in a similar level to a method of using the entire mesh data may be obtained. According to the present disclosure, algorithms for various operations may be applied using contact (collision) information between each physical particle 420 and a virtual object, and in this case, an appropriate number of the physical particles 420 may be distributed to prevent reduction in a computation speed of the physical engine due to an excessive number of particles while smoothing computation of such an operation algorithm by virtue of a sufficient number of particles. The appropriate number of the physical particles 420 may be derived through an experiment, and for example, about 130 of physical particles 420 in total may be distributed and arranged on both hands.

The plurality of physical particles 420 may have various shapes, but may have a spherical shape with a unit size for simplifying computation. The plurality of physical particles 420 may have various physical quantities. The physical quantities may include positions at which the plurality of physical particles 420 are arranged to correspond to predetermined finger bones of a virtual hand 310. Force applied to the plurality of physical particles 420 may have respective magnitudes and directions. The plurality of physical particles 420 may further have a physical quantity such as a coefficient of friction or an elastic modulus.

According to the present disclosure, whether the physical particle 420 of the virtual hand contacts the virtual object may be determined. According to the present disclosure, as a method of determining whether the physical particle 420 and the virtual object contact each other, an axis-aligned bounding box (AABB) collision detection method may be used.

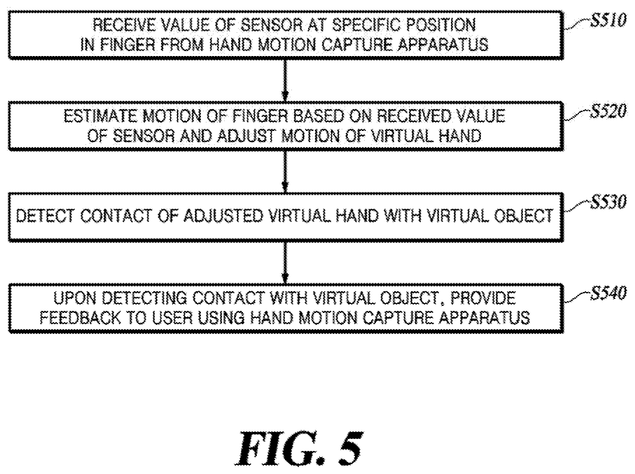

FIG. 5 is a flowchart of a method of manipulating an object in virtual or augmented reality based on a hand motion capture apparatus providing haptic feedback according to an embodiment of the present disclosure.

A value of a sensor at a specific position in a finger may be input from the hand motion capture apparatus (S510). The sensor may be a 3D magnetic sensor, and a position of the sensor may be a finger end and a finger start point.

A motion of the finger may be estimated based on the input value of the sensor and a motion of a virtual hand may be adjusted (S520). That is, the motion of the hand may be estimated from the input value of the sensor. In detail, a yaw of the finger start point and a pitch of the finger joint may be estimated. A motion of the virtual hand may be adjusted to correspond to the estimated motion of the finger. The virtual hand may be modeled for each user based on the value of the sensor. Alternatively, the virtual hand may be separately modeled for each user.

Contact of the adjusted virtual hand with a virtual object may be detected (S530). In detail, a plurality of physical particles may be disposed on an index that contacts with the virtual hand during a hand operation of the virtual hand, and whether a physical particle contacts the virtual object among the physical particles may be detected.

When contact with the virtual object is detected, feedback may be provided to the user using the hand motion capture apparatus (S540). Feedback may be provided to the user via vibration intensity depending on the number of physical particles that contact the virtual object and a penetration depth when the physical particle and the virtual object contact each other. For example, feedback may be provided only to a finger on which the physical particle that contacts the virtual object is positioned and feedback may be differently provided for each finger.

Although FIG. 5 illustrates the case in which operations S510 to S540 are sequentially performed, this is merely an example of an embodiment of the present disclosure. In other words, it would be obvious to one of ordinary skill in the art that the embodiment of the present disclosure may be changed and modified in various ways, for example, an order illustrated in FIG. 5 may be changed or one or more of operations S510 to S540 may be performed in parallel to each other, and thus, FIG. 5 is not limited to the time-series order.

The procedures shown in FIG. 5 can also be embodied as computer readable code stored on a computer readable recording medium. The computer readable recording medium is any data storage device that can store data which can thereafter be read by a computer. That is, examples of the computer-readable recording medium include a magnetic storage medium (e.g., a read-only memory (ROM), a random-access memory (RAM), a floppy disk, or a hard disk), and an optical reading medium (e.g., a compact disc (CD)-ROM or a digital versatile disc (DVD)). The computer-readable recording medium may be distributed over network coupled computer systems so that the computer-readable code may be stored and executed in a distributed fashion.

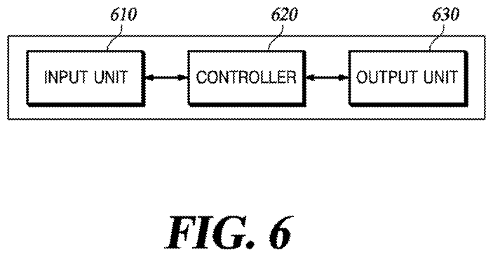

FIG. 6 is a diagram showing a configuration of an object manipulation apparatus in virtual or augmented reality based on a hand motion capture apparatus providing haptic feedback according to an embodiment of the present disclosure.

Although the case in which the apparatus illustrated in FIG. 6 is divided into a plurality of components has been described, the plural components may be integrated as one component or one component is divided into a plurality of components.

The object manipulation apparatus may include an input unit 610, a controller 620, and an output unit 630.

The input unit 610 may receive a value of a sensor at a specific position in a finger from the hand motion capture apparatus. In detail, the received value of the sensor may be an angle at which a finger start point and a finger end rotate around the x, y, and z axes.

The controller 620 may estimate a motion of a finger based on the value of the sensor to adjust a motion of a virtual hand. That is, the motion of the finger may be estimated from the received value of the sensor. In other words, a yaw of the finger start point and a pitch of the finger joint may be estimated. A motion of the virtual hand may be adjusted to correspond to the estimated motion of the finger. The virtual hand may be modeled for each user based on the value of the sensor. Alternatively, the virtual hand may be separately modeled for each user.

The controller 620 may detect contact of the adjusted virtual hand with a virtual object. A plurality of physical particles may be disposed on an index that contacts with the virtual hand during a hand operation of the virtual hand, and whether a physical particle contacts the virtual object among the physical particles may be detected.

Upon detecting contact with the virtual object, the output unit 630 may provide feedback to the user using the hand motion capture apparatus. Feedback may be provided to the user via vibration intensity depending on the number of physical particles that contact the virtual object and a penetration depth when the physical particle and the virtual object contact each other. For example, feedback may be provided only to a finger on which the physical particle that contacts the virtual object is positioned and feedback may be differently provided for each finger. In addition, feedback may be provided to a position corresponding to the physical particle.

As apparent from the above description, according to the present embodiment, contact between a virtual hand and a virtual object may be determined and intensity of feedback may be adjusted and may be provided to a user depending on an interaction therebetween.

According to the present embodiment, a user hand modeled in virtual reality or augmented reality may be used to enhance sense of reality and accuracy of the user.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A method of manipulating an object in virtual or augmented reality based on a hand motion capture apparatus providing haptic feedback, the method comprising:
receiving a value of a sensor at a specific position in a finger from the hand motion capture apparatus;
estimating a motion of the finger based on the value of the sensor and adjusting a motion of a virtual hand;
detecting contact of the adjusted virtual hand with a virtual object; and
upon detecting the contact with the virtual object, providing feedback to a user using the hand motion capture apparatus,
wherein the virtual hand is modeled for each user.

2. The method according to claim 1, further comprising modeling the virtual hand based on the value of the sensor.

3. The method according to claim 1, wherein the detecting the contact of the adjusted virtual hand with the virtual object includes disposing a plurality of physical particles on an index on which contact occurs during a hand operation of the virtual hand and detecting whether the physical particle contacts the virtual object.

4. The method according to claim 3, wherein, upon detecting the contact with the virtual object, providing feedback to the user using the hand motion capture apparatus, includes providing feedback to the user via vibration intensity depending on the number of physical particles that contact the virtual object and a penetration depth when the physical particle and the virtual object contact each other.

5. The method according to claim 1, wherein the virtual hand modeled for each user is modeled by calculating a width, a length, and a thickness of a palm of the user, and a length of a finger from the value of the sensor and estimating a width and a thickness of the finger from the calculated width, length, and thickness of the palm and the calculated length of the finger.

6. The method according to claim 1, wherein the estimated motion of the finger is a yaw of a finger start point and a pitch of a joint of the finger.

7. An object manipulation apparatus in virtual or augmented reality based on a hand motion capture apparatus providing haptic feedback, the apparatus comprising:
an input unit configured to receive a value of a sensor at a specific position in a finger from the hand motion capture apparatus;
a controller configured to estimate a motion of the finger based on the value of the sensor, to adjust a motion of a virtual hand, and to detect contact of the adjusted virtual hand with a virtual object; and
an output unit configured to provide feedback to a user using the hand motion capture apparatus upon detecting the contact with the virtual object,
wherein the controller models the virtual hand for each user.

8. The apparatus according to claim 7, wherein the controller models the virtual hand based on the value of the sensor.

9. The apparatus according to claim 7, wherein the controller disposes a plurality of physical particles on an index on which contact occurs during a hand operation of the virtual hand and detects whether the physical particle contacts the virtual object.

10. The apparatus according to claim 9, wherein the output unit provides feedback to the user via vibration intensity depending on the number of physical particles that contact the virtual object and a penetration depth when the physical particle and the virtual object contact each other.

11. The apparatus according to claim 7, wherein the virtual hand modeled for each user is modeled by calculating a width, a length, and a thickness of a palm of the user, and a length of a finger from the value of the sensor and estimating a width and a thickness of the finger from the calculated width, length, and thickness of the palm and the calculated length of the finger.

12. The apparatus according to claim 7, wherein the estimated motion of the finger is a yaw of a finger start point and a pitch of a joint of the finger.
